(19) United States
(12) Patent Application Publication
(10) Pub. No.: US 2006/0071358 A1
(43) Pub. Date: Apr. 6, 2006

(54) APPARATUS AND METHOD FOR DELIVERING POLYURETHANE FORMING METHODS

(75) Inventors: Joseph T. Donatti, Howell, MI (US); Ian S. Williams, Howell, MI (US); Jerome J. Sroka, St. Clair Shores, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/711,761

(22) Filed: Oct. 4, 2004

(51) Int. Cl. B29C 31/00

(52) U.S. Cl. 264/85; 264/240; 264/309; 425/100

(57) ABSTRACT

An apparatus for supplying differently colored polyurethane forming materials includes a source of isocyanate, a source of polyol, multiple colorant sources for supplying multiple colorants, and multiple premix chambers that are each connected to a respective colorant source and one of the source of isocyanate and the source of polyol. Each premix chamber has a mixing element for mixing a respective colorant and one of isocyanate and polyol to form a selectively colored material. The apparatus further includes a spray head in communication with the premix chambers and the other of the source of isocyanate and the source of poloyl, and a valve assembly disposed between the spray head and the premix chambers for selectively introducing selectively colored material from one of the premix chambers and the other of isocyanate and polyol to the spray head.

### BACKGROUND OF THE INVENTION

1. Field of the Invention

The invention relates to an apparatus and method for delivering polyurethane forming materials.

2. Background Art

A prior method of introducing colorant into polyurethane forming materials involves mixing various colorants with catalyzed or non-catalyzed polyol in drums that are later stored until needed. A particular drum is then selected for a molding cycle, and the drum is connected to a mix or spray head. Next, colored polyol is pumped directly from the drum to the spray head along with unpigmented isocyanate, and the materials are sprayed into a mold to form a colored part.

There are several disadvantages associated with the above method. First, the method involves handling and storage of multiple large drums. Second, colored polyol in the drums may deviate from a desired color due to such factors as settling and contamination. Third, drums must be exchanged in order to effect a color change.

Another method of introducing colorant into polyurethane forming materials involves introducing colorant directly into a spray head along with separate streams of polyol and isocyante. The components are then mixed in the spray head and sprayed into a mold. With this method, however, sufficient mixing of the components may be difficult to achieve. As a result, problems with color repeatability and consistency may occur.

### SUMMARY OF THE INVENTION

Under the invention, an apparatus is provided for supplying differently colored polyurethane forming materials. The apparatus includes a source of isocyanate, a source of polyol, multiple colorant sources for supplying multiple colorants, and multiple premix chambers that are each connected to a respective colorant source and one of the source of isocyanate and the source of polyol. Each premix chamber has a mixing element for mixing a respective colorant and one of isocyanate and polyol to form a selectively colored material. The apparatus further includes a spray head in communication with the premix chambers and the other of the source of isocyanate and the source of poloyl, and a valve assembly disposed between the spray head and the premix chambers for selectively introducing selectively colored material from one of the premix chambers and the other of isocyanate and polyol to the spray head.

A method according to the invention of supplying differently colored polyurethane forming materials includes the following steps: a) supplying one of isocyanate and polyol to a selected one of multiple premix chambers; b) supplying colorant from a selected one of multiple colorant sources to the selected one of the premix chambers; c) mixing the colorant with the one of isocyanate and polyol in the selected one of the premix chambers to form a mixture of selectively colored material; d) supplying the selectively colored material and the other of polyol and isocyanate to a spray head; and e) repeating a), b), c) and d) by selecting a different premix chamber in a) and a different colorant in b).

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic view of an apparatus according to the invention for manufacturing a consecutive stream of differently colored parts; and

FIG. 2 is a cross-sectional view of a part made by the apparatus of FIG. 1.

### DETAILED DESCRIPTION OF THE PREFERRED EMBODIMENT(S)

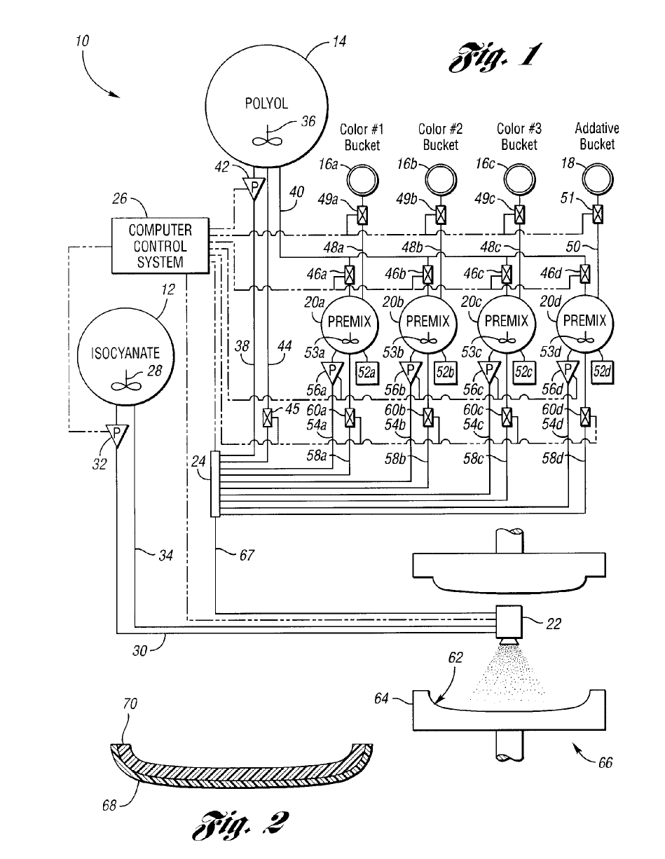

FIG. 1 shows an apparatus 10 according to the invention for manufacturing a consecutive stream of differently colored parts that comprise polyurethane. Such parts may include, for example, door panels, dashboards, package shelves, headliners, etc. The apparatus 10 includes a source of isocyanate 12, a source of polyol 14, multiple colorant sources 16a-c, an additive source 18, multiple premix chambers 20a-d that are each connected to the source of polyol 14 and a respective colorant source 16a-c or additive source 18, a spray head 22, a valve assembly 24 for selectively introducing polyol and colorant from one of the premix chambers 20a-c to the spray head 22, and a control system 26.

The source of isocyanate 12 may include unpigmented isocyanate and a mixing element 28, such as a rotatable agitator, for agitating the isocyanate. In the embodiment shown in FIG. 1, the source of isocyanate 12 is connected directly to the spray head 22 by a main line 30. A first pump 32 is also disposed in the main line 30 for pumping isocyanate to the spray head 22. A recirculation line 34 may also be provided for returning unused isocyanate to the source of isocyanate 12 to inhibit the isocyanate from stagnating in main line 30.

The source of polyol 14 may include unpigmented polyol mixed with a catalyst that facilitates the reaction of the polyol with isocyanate. Alternatively, the source of polyol 14 may include uncatalyzed polyol. The source of polyol 14 may also include one or more additives, such as a surfactant for controlling or stabilizing cell structure in the manufactured parts, and a mixing element 36, such as a rotatable agitator, for mixing the components together. An example of a suitable surfactant is 8715-LF, which is available from Goldschmidt Chemical Corporation of Hopewell, Va.

In the embodiment shown in FIG. 1, the source of polyol 14 is connected to the valve assembly 24 and the premix chambers 20a-d by first and second main lines 38 and 40, respectively. A second pump 42 is disposed in the first main line 38 for pumping polyol to the valve assembly 24. A recirculation line 44 having a valve 45 may also be provided for returning unused polyol to the source of polyol 14 to inhibit the polyol from stagnating in the first main line 38. In addition, valves 46a-d may be provided for controlling the flow of polyol into the premix chambers 20a-d.

The colorant sources 16a-c provide multiple differently colored colorants to the premix chambers 20a-c via lines 48a-c. Each colorant source 16a-c includes a particular colorant, such as a liquid or powder color concentrate, and the flow of colorant can be controlled by valves 49a-c. Each colorant source 16a-c may also include a carrier material, such as polyol, to facilitate the flow of colorant, and a heating element to sufficiently melt colorant if the colorant is originally in solid form, such as powder for example. Suitable colorants may be obtained from Rite Systems of Chicago, Ill., or PolyOne Corporation of North Baltimore, Ohio, for example. A suitable carrier material is VORANOL™ 4701, available from The Dow Chemical Company of Midland, Mich.

The additive source 18 may include one or more additives, such as ultraviolet light stabilizers, blowing agents and/or foaming agents, and is configured to provide additives to premix chamber 20d via line 50. Additionally, the flow of additives may be controlled by valve 51. Alternatively or supplementally, such additives may be added to the source of polyol 14.

Each premix chamber 20a-d receives polyol from the source of polyol 14 and a colorant from one of the colorant sources 16a-c or additives from the additive source 18. Each premix chamber 20a-d may also be mounted on a weigh cell 52a-d that is used to determine the amount of material introduced into the premix chamber 20a-d. In addition, each premix chamber 20a-c includes a mixing element 53a-c, such as a rotatable agitator, for mixing the polyol with colorant to form a selectively colored polyol mixture. Similarly, the premix chamber 20d includes a mixing element 53d, such as a rotatable agitator, for mixing polyol with one or more additives from the additive source 18.

The premix chambers 20a-d are connected to the valve assembly 24 by lines 54a-d. A pump 56a-d may also be disposed in each line 54a-d for pumping selectively colored polyol or polyol mixed with additives to the valve assembly 24. In addition, recirculation lines 58a-d having valves 60a-d may be provided for returning unused materials to the premix chambers 20a-d to inhibit the materials from stagnating in the lines 54a-d.

The spray head 22 is in communication with the source of isocyanate 12, the source of polyol 14 and the premix chambers 20a-d. Furthermore, the spray head 22 is configured to mix and spray materials received from the sources 12, 14 and/or 20a-d on any suitable surface, such as a mold surface 62 of a lower mold portion 64 of a mold 66.

The valve assembly 24, which may be an automatic switching valve assembly for example, is disposed between the source of polyol 14 and the spray head 22, as well as between the premix chambers 20a-d and the spray head 22. In the embodiment shown in FIG. 1, the valve assembly 24 is connected to the spray head 22 by line 67. The valve assembly 24 is configured to selectively introduce polyol from the source of polyol 14, selectively colored polyol from one of the premix chambers 20a-c, and/or polyol mixed with additives from premix chamber 20d to the spray head 22. The valve assembly 24 may also be configured to route materials from one or more lines 38 and 54a-d to one or more respective recirculation lines 44 and 58a-d when such materials are not being supplied to the spray head 22.

The computer control system 26 may control all aspects of operation of the apparatus 10. For example, the computer control system 26 may control introduction of materials into the spray head 22 by controlling operation of the pumps 32, 42 and 56a-d and the valves 24, 45, 46a-d, 49a-d and 60a-d.

Operation of the apparatus 10 will now be described in detail. First, a desired amount of polyol may be introduced into each premix chamber 20a-d. For example, the computer control system 26 may be used to open the valves 46a-d until the weigh cells 52a-d indicate that a desired weight or mass of polyol has been delivered to each premix chamber 20a-d. As another example, flow meters located at or near the premix chambers 20a-d may be used to monitor the amount of polyol delivered to each premix chamber 20a-d. After the desired amount of polyol has been delivered, the vlaves 46a-d may be closed by the computer control system 26.

Next, the computer control system 26 may be used to open valves 48a-c to introduce a desired amount of colorant into each premix chamber 20a-c. Again, the weigh cells 52a-c and/or flow meters may be used to monitor the amount of colorant introduced into the premix chambers 20a-c. The amount of colorant required may depend on such factors as the type of colorant, such as organic or inorganic pigments or dyes, the concentration of the colorant and the desired final color.

Similarly, the computer control system 26 may be used to open valve 51 to introduce a desired amount of additives into premix chamber 20d. Alternatively or supplementally, desired additives may be added to the source of polyol 14 and/or to each premix chamber 20a-c.

Next, the computer control system 26 may activate the mixing elements 53a-d to mix together the polyol and colorant, or polyoly and additives. The mixing elements 53a-d may be used to agitate the materials prior to operation of the spray head 22, as well as during operation of the spray head 22 to ensure that the materials remain sufficiently mixed.

When part production is ready to begin, the computer control system 26 may be used to control the valve assembly 24 so as to introduce desired materials to the spray head 22. For example, if it is desired to manufacture a first part having a first color, the computer control system 26 may activate pump 56a and control valve assembly 24 to allow delivery of selectively colored polyol from premix chamber 20a to the spray head 22. Simultaneously, the computer control system 26 also activates pump 32 to deliver isocyanate from the source of isocyanate 12 to the spray head 22. The spray head 22 functions to mix the selectively colored polyol and the isocyanate and to spray the mixed material onto the mold surface 62, or other surface, such that the mixed material reacts to form polyurethane.

During the above process, the computer control system 26 may also activate pump 56d to deliver polyol mixed with additives from premix chamber 20d to the valve assembly 24. These materials may then mix in the valve assembly 24 with the selectively colored polyol provided by the premix chamber 20a, and this mixture may be supplied to spray head 22 via line 67.

If the entire thickness of the first part does not need to be colored, the valve assembly 24 may be controlled to shut off flow of the selectively colored polyol from the premix chamber 20a, after a layer of material has been sprayed onto the mold surface 62, and to allow flow from the source of polyol 14 to the spray head 22. The spray head 22 may then mix polyol from the source of polyol 14 with isocyanate from the source of isocyanate 12, and spray the mixture on the layer of previously sprayed material. The mold 66 may then be closed to form the first part.

In this way, referring to FIG. 2, the first part may be formed with a first layer or portion 68 of colored polyurethane, and a second layer or portion 70 of unpigmented polyurethane. Moreover, each portion 68 and 70 may have any suitable thickness. For example, the first portion 68 may have a thickness in the range of 0.3 millimeters (mm) to 0.5 mm, and the second portion 70 may have a thickness in the range of 0.3 to 0.7 mm or 0.5 to 1.5 mm.

If it is desired to make a second part having a different color, the computer control system 26 may be used to activate pump 56b and control valve assembly 24 to allow delivery of selectively colored polyol from premix chamber 20b to the spray head 22. Simultaneously, the computer control system 26 may activate pump 32 to deliver isocyanate from the source of isocyanate 12 to the spray head 22. As described above, the spray head 22 then functions to mix the selectively colored polyol and the isocyanate and to spray the mixed material onto the mold surface 62, or other surface, such that the mixed material reacts to form polyurethane.

The computer control system 26 may also activate pump 56d to deliver polyol mixed with additives from premix chamber 20d to the valve assembly 24 at the same time selectively colored polyol is being delivered from the premix chamber 20b to the valve assembly 24. The materials supplied from the premix chamber 20d may then mix in the valve assembly 24 with the selectively colored polyol provided by the premix chamber 20b, and this mixture may be supplied to spray head 22 via line 67.

Again, if the entire thickness of the second part does not need to be colored, the valve assembly 24 may be controlled to shut off flow of the selectively colored polyol from the premix chamber 20b, after a layer of material has been sprayed onto the mold surface 62, and to allow flow from the source of polyol 14 to the spray head 22. The spray head 22 may then mix polyol from the source of polyol 14 with isocyanate from the source of isocyanate 12, and spray the mixture on the layer of previously sprayed material. The mold 66 may then be closed to form the second part.

The above process may be repeated to produce multiple polyurethane parts, and the apparatus 10 may be controlled to selectively provide selectively colored polyol from one of the premix chambers 20a-c during formation of each part. As a result, a consecutive stream of differently colored parts may be produced using a single source of isocyanate and a single source of polyol.

During formation of a particular part, the apparatus 10 may be controlled to supply polyol from the source of polyol 14, selectively colored polyol from one or more of the premix chambers 20a-c, and/or polyol mixed with additives from premix chamber 20d to the spray head 22. As a result, the spray head 22 may be operated to mix and spray one or more of these materials with isocyanate supplied by the source of isocyanate 12 so as to form the part.

The line 67 between the valve assembly 24 and the spray head 22 may be made as short as possible to reduce the amount of material that may need to be purged between the molding of differently colored parts. Moreover, the supply of selectively colored polyol may be switched from one premix chamber 20a-c to another premix chamber 20a-c during the latter stages of formation of a particular part, so that the selectively colored polyol used to complete that part is the same as that required to form at least a portion of the next consecutive part. As a result, no purging of the line 67 may be required. Furthermore, with such a process, a non-show surface of each part, such as a back surface, may be formed of a different color material than the rest of the part.

Because the supply of selectively colored polyol may be automatically switched from one premix chamber 20a-c to another premix chamber 20a-c, the apparatus 10 is able to efficiently produce differently colored parts. Furthermore, because colorants are premixed with polyol in the premix chambers 20a-c, the apparatus 10 eliminates the need for storage and handling of drums containing colorant mixed with polyol.

Alternatively, the apparatus 10 may be configured such that isocyanate from the source of isocyanate 12 is provided to each premix chamber 20a-d, and polyol from the source of polyol 14 is provided directly to the spray head 22. With such a configuration, the source of isocyanate 12 and the source of polyol 14 shown in FIG. 1 essentially switch places. As a result, isocyanate may be mixed with colorant from one of the colorant sources 16a-c or additives from the additive source 18 in the premix chambers 20a-d, such that selectively colored isocyanate and/or isocyanate mixed with additives may be provided to the spray head 22, along with polyol from the source of polyol 14.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. For example, the number of colorant sources 16a-c and premix chambers 20a-d may be increased or decreased as needed.

What is claimed is:

1. An apparatus for supplying differently colored polyurethane forming materials, the apparatus comprising:
a source of isocyanate;
a source of polyol;
multiple colorant sources for supplying multiple colorants;
multiple premix chambers that are each connected to a respective colorant source and one of the source of isocyanate and the source of polyol, each premix chamber having a mixing element for mixing a respective colorant and one of isocyanate and polyol to form a selectively colored material;
a spray head in communication with the premix chambers and the other of the source of isocyanate and the source of poloyl; and
a valve assembly disposed between the spray head and the premix chambers for selectively introducing selectively colored material from one of the premix chambers and the other of isocyanate and polyol to the spray head.

2. The apparatus of claim 1 wherein the source of polyol includes a catalyst.

3. The apparatus of claim 1 wherein the source of polyol includes non-catalyzed polyol.

4. The apparatus of claim 1 further comprising an additive source including an ultraviolet light stabilizer, and an additional premix chamber connected to the source of polyol and the additive source, the additional premix chamber having a mixing element for mixing polyol and the ultraviolet light stabilizer, the additional premix chamber further being in communication with the spray head for supplying polyol mixed with ultraviolet light stabilizer to the spray head.

5. The apparatus of claim 1 further comprising multiple pumps, each pump being disposed between a respective premix chamber and the valve assembly.

6. The apparatus of claim 5 further comprising first and second additional pumps, the first additional pump being disposed between the source of isocyanate and the spray head, and the second additional pump being disposed between the source of polyol and the spray head.

7. The apparatus of claim 1 wherein each premix chamber is connected to the source of polyol, and the spray head is in communication with the source of isocyanate.

8. An apparatus for supplying polyurethane forming materials, the apparatus comprising:
a source of isocyanate;
a source of polyol;
a first colorant source for supplying a first colorant;
a first premix chamber connected to the source of polyol and the first colorant source, the first premix chamber having a mixing element for mixing polyol and the first colorant;
a spray head in communication with the source of isocyanate, the source of polyol and the premix chamber; and
a valve assembly disposed upstream of the spray head for selectively introducing polyol from the source of polyol or polyol and first colorant from the first premix chamber to the spray head.

9. The apparatus of claim 8 further comprising a second colorant source for supplying a second colorant, and a second premix chamber connected to the source of polyol and the second colorant source, the second premix chamber having a mixing element for mixing polyol and the second colorant, wherein the valve assembly is operative to introduce polyol from the source of polyol, polyol and first colorant from the first premix chamber, or polyol and second colorant from the second premix chamber to the spray head.

10. The apparatus of claim 8 further comprising first, second and third pumps, the first pump being disposed between the source of isocyanate and the spray head, the second pump being disposed between the source of polyol and the spray head, and the third pump being disposed between the first premix chamber and the valve assembly.

11. A method of supplying differently colored polyurethane forming materials, the method comprising:
a) supplying one of isocyanate and polyol to a selected one of multiple premix chambers;
b) supplying colorant from a selected one of multiple colorant sources to the selected one of the premix chambers;
c) mixing the colorant with the one of isocyanate and polyol in the selected one of the premix chambers to form a mixture of selectively colored material;
d) supplying the selectively colored material and the other of polyol and isocyanate to a spray head; and
e) repeating a), b), c) and d) by selecting a different premix chamber in a) and a different colorant in b).

12. The method of claim 11 wherein step a) includes supplying polyol to the selected one of the premix chambers, and step d) includes supplying isocyanate to the spray head.

13. The method of claim 12 wherein the polyol includes a catalyst.

14. The method of claim 12 wherein the polyol is non-catalyzed.

15. The method of claim 12 further comprising spraying the selectively colored material and isocyanate from the spray head into a mold to form a first portion of a first part, subsequently supplying unpigmented polyol to the spray head, and spraying the unpigmented polyol and isocyanate from the spray head into the mold to form a second portion of the first part.

16. The method of claim 11 wherein each colorant source includes a liquid colorant.

17. The method of claim 11 further comprising introducing nitrogen into the selected one of the premix chambers to reduce moisture.

18. The method of claim 11 further comprising recirculating one mixture of selectively colored material to one of the premix chambers when the selectively colored material is not being supplied to the spray head.
